(19) United States
(12) Patent Application Publication
(10) Pub. No.: US 2003/0198843 A1
(43) Pub. Date: Oct. 23, 2003

(54) Hydrocarbon fueled liquid gallium fuel generator system

(75) Inventor: Ralph C. Struthers, Santa Maria, CA (US)

Correspondence Address: FULWIDER PATTON LEE & UTECHT, LLP, 200 OCEANGATE, SUITE 1550, LONG BEACH, CA, 90802, US

(73) Assignee: Enernext, LLC

(21) Appl. No.: 10/126,610

(22) Filed: Apr. 19, 2002

(51) Int. Cl. H01M 8/06

(52) U.S. Cl. 429/20; 429/17; 422/188; 422/198

(57) ABSTRACT

Apparatus including a gallium fuel generator configured to convert gallium hydroxide to gallium fuel, the generator comprising a combustor for receipt and combustion of hydrocarbon fuel and an oxidizing gas to form a pressurized hot gas mixture including reducing gases, a dehydrator for dehydrating gallium hydroxide to gallium sesquioxide, a reducer configured to receive the gallium sesquioxide and hot gas mixture to form by reduction an intermixture including spent gases and gallium fuel, and a gallium fuel separator configured to receive and separate the gallium fuel from the intermixture.

### BACKGROUND OF THE INVENTION

Fuel cells are electrochemical devices that convert the chemical energy of reaction directly into electrical energy. A fuel cell, although having similar components and several characteristics, differs from a typical battery in several respects. The battery is an energy storage device, that is, the maximum energy that is available is determined by the amount of chemical reactant stored within the battery itself. Thus, the battery will cease to produce electrical energy when the chemical reactants are consumed (i.e., discharged). The fuel cell, on the other hand, is an energy conversion device, which theoretically has the capability of producing electrical energy for as long as the fuel and oxidant are supplied to the electrodes.

Fuel cells provide a new and promising option for the efficient conversion of fossil fuels to electricity. Commercial development of fuel cell technology has been underway in the Untied States since the late 1960s with the U.S. Government playing a prominent role.

In the art of electrochemical fuel cells, electric current is produced as a byproduct of chemical reaction occurring between an anode and a cathode. Prior art cells have been proposed utilizing metallic anode electrodes, porous cathode electrodes through which air is fed into the cell as an oxidant, and alkaline electrolytic contact between the anode and cathode electrodes. For example, described in U. S. Pat. No. 4,477,539 issued to applicant, Ralph C. Struthers on Oct. 16, 1984, and entitled “METAL/GAS FUEL CELL”, is an electrochemical fuel cell that employs an anode electrode in the form of an aluminum plate, a gas cathode electrode, and two electrolytic alkaline solutions separated by a membrane. The solid aluminum anode electrode is immersed in one of the electrolytic solutions wherein hydroxyl ions are presented for reaction with the metal to form aluminum hydroxide and freeing electrons for the conduct of useful work. As a result of the reaction to form aluminum hydroxide, the solid metal anode is consumed increasing the distance between the cathode and the anode which results in current change. As the fuel is consumed the anode fuel supply becomes depleted and requires replenishment to sustain operation of the cell.

Prior art systems have been proposed that generate anodic fuel. For example, described in U.S. Pat. No. 5,429,886, issued to applicant Ralph C. Struthers on Jul. 4, 1995, and entitled, “HYDROCARBON (HYDROGEN)/AIR AEROGEL CATALYZED CARBON ELECTRODE FUEL CELL SYSTEM” is a hydrogen fuel generator that produces hydrogen fuel in the form of hydrogen gas for use in a hydrogen fuel cell.

Additionally, described in U.S. Pat. No. 6,083,425 issued to Clawson et al., on Jul. 4, 2000, and entitled, “METHOD FOR CONVERTING HYDROCARBON FUEL INTO HYDROGEN GAS AND CARBON DIOXIDE” is a hydrogen fuel generator that produces hydrogen fuel for use in a hydrogen fuel cell.

### SUMMARY OF THE INVENTION

This invention relates to a hydrocarbon fueled, liquid gallium fuel generator system and apparatus in combination with liquid gallium alkaline electrolyte fuel cells. One important application for this invention is generating liquid gallium fuel for use in liquid gallium alkaline electrolyte fuel cells that convert chemical energy into electricity. In a typical liquid gallium fuel cell, liquid gallium is utilized as the anodic fuel and an aqueous electrolytic alkaline solution is provided to present negatively charged hydroxyl ions for reaction with the gallium fuel. The hydroxyl ions react with the fuel to form Ga(OH)₄⁻ ions and produce free electrons for transmission out of the cell for useful work. The Ga(OH)₄⁻ ions are regenerated to form gallium hydroxide Ga(OH)₃ and hydroxyl ions (OH⁻) in the solution. Through formation of Ga(OH)₄⁻ ions and gallium hydroxide the reacted gallium (Ga) is spent in such states from further use as fuel. The reacted gallium, however, may be reconstituted back to its elemental state for use as gallium fuel through use of the fuel generator of present invention.

Hydrocarbon fuel is utilized in the present invention to provide reaction components and heat to convert gallium hydroxide to gallium fuel. The generator of the present invention maybe fueled by a variety of hydrocarbons including gasoline, propane, methanol, ethanol, kerosene, pentane, and butane, and other fuels as known to those skilled in the art.

The present invention may be utilized, for example, in the provision of fuel cell powered electric vehicles that are efficient, reduce noise and emissions and unburdened of the problems associated with the use of short range batteries that need to be charged; and, current gasoline-electric hybrid vehicles that need a gasoline combustion engine. Such vehicles will gain about three times the fuel mileage of comparable vehicles with internal combustion engines. Accordingly, the existing petroleum fuel infrastructure in the United States and in many foreign countries for producing and distributing hydrocarbon fuels is practical and economical for fueling such vehicles.

The foregoing and other objects and features of my invention will be fully understood from the following detailed description of typical forms and applications of the invention, throughout which description reference is made to the accompanying drawings. These and other features and advantages of the present invention will become apparent from the following detailed description which, taken in conjunction with the accompanying drawings, illustrates by way of example the principles of the invention.

### BRIEF DESCRIPTION OF THE DRAWINGS

FIG. 1 is a schematic illustration of my new liquid gallium fuel generator system for processing byproduct from a liquid gallium-air alkaline electrolyte fuel cell;

FIG. 2 is an enlarged in scale sectional view of the liquid gallium fuel generator and gallium fuel tank shown in FIG. 1;

FIG. 3 is a schematic diagram of a liquid gallium-air alkaline electrolyte fuel cell with the generator, in reduced scale, for processing spent gallium fuel byproduct;

FIG. 4 is the theoretical oxidation and reduction half-reactions and net reaction chemical formula of my liquid gallium-air alkaline electrolyte fuel cell system;

FIG. 5 is the theoretical standard cell potentials for half-reactions, net-reactions; Gibbs free energy and energy available from liquid gallium fuel for my liquid gallium-air alkaline electrolyte fuel cell system;

FIG. 6 is a schematic illustration of my new liquid gallium fuel generator system in which a liquid gallium-air alkaline electrolyte fuel cell is utilized and including two carbon dioxide separators;

FIG. 7 is a flow diagram of a direct acting reciprocating steam-driven high-pressure gas pump suitable for use with the system shown in FIGS. 1 and 6;

FIG. 8 is a theoretical computation of reaction efficiencies of my liquid gallium-air alkaline electrolyte fuel cell and generator system when gasoline is used as the hydrocarbon fuel and air is utilized as the oxidizer;

FIG. 9 is a theoretical computation of reaction efficiencies of my liquid gallium-air alkaline electrolyte fuel cell and generator system when propane is used as the hydrocarbon fuel and air is utilized as the oxidizer;

FIG. 10 is a theoretical computation of reaction efficiencies of my liquid gallium-air alkaline electrolyte fuel cell and generator system when methanol is used as the hydrocarbon fuel and air is utilized as the oxidizer;

FIG. 11 is a theoretical computation of reaction efficiencies of my liquid gallium-air alkaline electrolyte fuel cell and generator system when ethanol is used as the hydrocarbon fuel and air is utilized as the oxidizer;

FIG. 12 is a theoretical computation of reaction efficiencies of my liquid gallium-air alkaline electrolyte fuel cell and generator system when kerosene is used as the hydrocarbon fuel and air is utilized as the oxidizer; and

FIG. 13 is a theoretical computation of reaction efficiencies of my liquid gallium-air alkaline electrolyte fuel cell and generator system when pentane is used as the hydrocarbon fuel and air is utilized as the oxidizer.

### DETAILED DESCRIPTION OF THE PREFERRED EMBODIMENTS

The system and apparatus of the present invention operates to provide liquid gallium fuel that is free of carbon monoxide, carbon dioxide, sulfur, and nitrogen. The invention is particularly suitable to providing liquid gallium fuel for use in an extremely efficient liquid gallium alkaline electrolyte fuel cell that converts chemical energy into electricity. Such systems might be used in electric powered vehicles in lieu of or in conjunction with vehicles powered by internal combustion engines and other such devices. Liquid gallium alkaline electrolyte fuel cells can, for example, be coupled to the gallium fuel generator and may be mounted aboard an electric powered vehicle (not shown or described). A variety of hydrocarbons such as gasoline, propane, methanol, ethanol, kerosene, pentane, or butane can fuel the liquid gallium fuel generator.

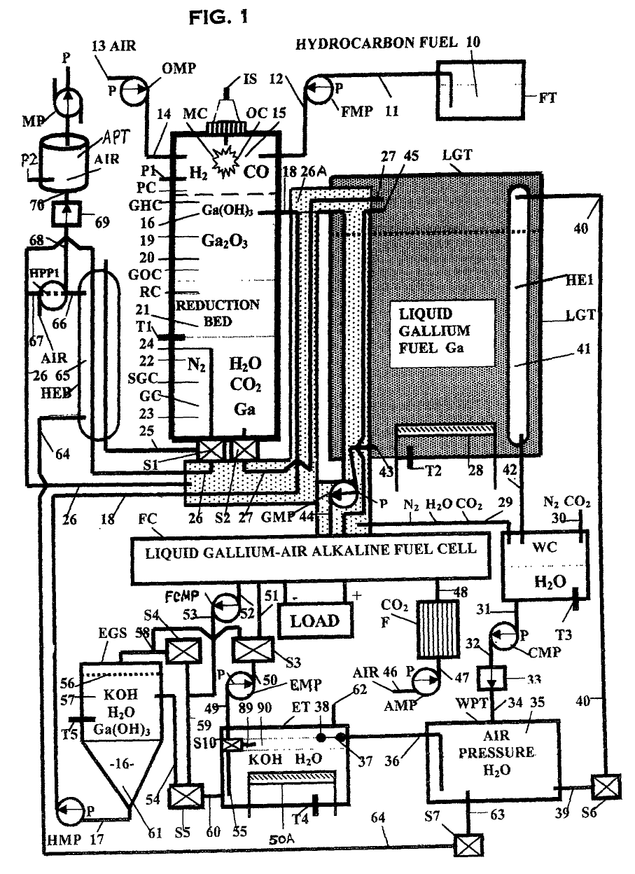

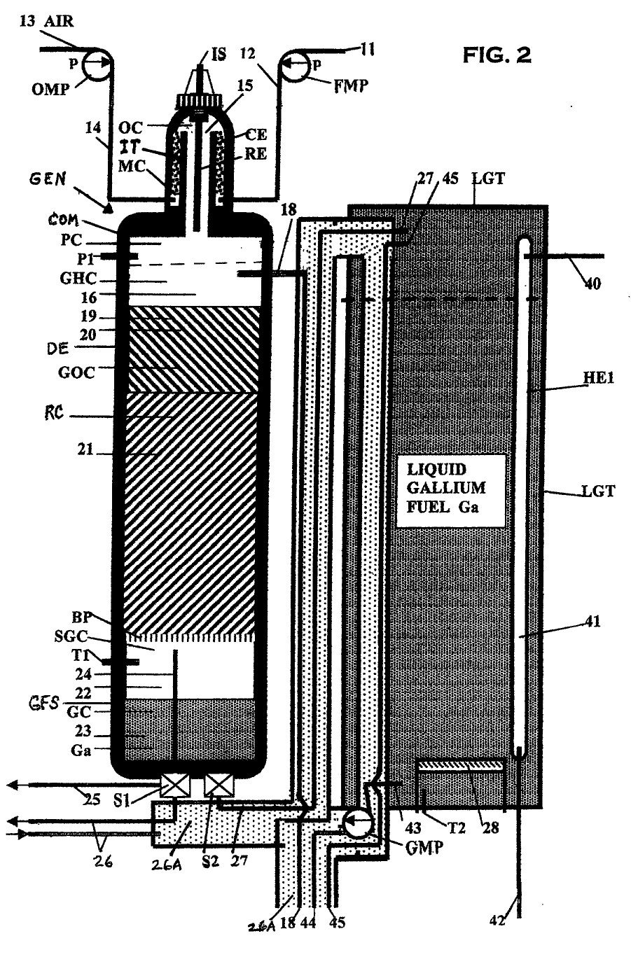

Referring to FIG. 1 and FIG. 2, a propellant P powered fuel-metering pump FMP receives hydrocarbon fuel 10 from a line 11 extending from a fuel tank FT and delivers the hydrocarbon fuel through a line 12 into a porous mixing and vaporizing chamber MC of a combustor section COM located at the upstream end of a tank-like generator GEN structure. In addition, a propellant P powered oxidizer-metering pump OMP delivers an air oxidizer 13 through a line 14 into the porous mixing and vaporizing chamber MC. The combustor section of the generator also includes an oxidizing chamber OC and a pressure chamber PC.

The air oxidizer 13 and hydrocarbon fuel 10 within the porous mixing and vaporizing chamber MC are mixed and vaporized to form a combustible gas mixture 15. This combustible gas mixture flows from the mixing chamber MC into and throughout the oxidizing chamber OC within the tank-like generator GEN. An ignitor IS within the oxidizing chamber OC detonates the combustible mixture, thereby at least partially oxidizing the hydrocarbon fuel and forming a pressurized hot gas mixture which flows into the pressure chamber PC. The hot gas mixture is expelled out of the pressure chamber of the combustor COM and into a dehydrator DE section of the generator, the generator also including a reducer section RC followed by a gallium fuel separator section GFS, the fuel separator located at the downstream end of the generator.

The combustor COM portion of the generator GEN includes a narrow elongate exterior cylindrical shell CE with a closed top and an opening at the bottom of the shell into the pressure chamber PC. The closed top supports an ignitor IS that extends through the shell wall and inside the combustor forming an elongate rod electrode RE positioned centrally along a portion of the longitudinal axis of the shell. Disposed radially about the rod electrode and between the rod electrode and the shell is an interior cylinder IT having an open top and bottom, the open bottom of the interior cylinder also forming the open bottom of the shell and extending into the pressure chamber PC for passage of the pressurized hot gas mixture. Formed between the interior cylinder and the shell is the mixing chamber MC with a closed bottom and open top and configured for receipt and mixing together of the hydrocarbon fuel 10 received from line 12 and the oxidizer 13 received from line 14 to form the combustible gas mixture 15. The rod electrode is suitably electrically energized to generate high voltage arcs within the oxidizing chamber OC. The combustible gas mixture formed in the mixing chamber MC and advances to the oxidizing chamber OC where it is detonated forming the pressurized hot gas mixture which then advances or flows into the pressure chamber PC down stream thereof. Attached to the pressure chamber is a pressure sensor P1 which monitors the pressure level of the pressure chamber to control an expulsion pressure valve (not shown) to the dehydrator. It is intended that reference to the term line herein may include within its meaning a passage for the transfer of material, a pipe, a conduit, etc.

In a startup mode, and with the use of air as the oxidizing gas, the hot gas mixture in the pressure chamber PC includes carbon dioxide, nitrogen, steam, and sometimes sulfur. The hot gas mixture may not include nitrogen if pure oxygen gas is used as the oxidizing gas.

In an operational mode, and with the use of air as the oxidizing gas, the hot gas mixture in the pressure chamber PC includes hydrogen, carbon monoxide, nitrogen, and steam (it might also contain sulfur if that gas is present). The hot gas mixture may not include nitrogen if pure oxygen gas is used as the oxidizing gas.

Referring again to FIG. 1 and FIG. 2, a propellant P powered gallium hydroxide-metering pump HMP moves gallium hydroxide Ga(OH)₃ 16 from an electrolyte gallium hydroxide separator EGS through lines 17 and 18 into a gallium hydroxide chamber GHC of the dehdyrator DE, the dehydrator also including a gallium oxide chamber GOC to remove water from the gallium hydroxide 16 and form gallium sesquioxide Ga₂O₃ 19. Into the gallium hydroxide chamber is inserted the gallium hydroxide from line 18 and the hot gas mixture expelled from the pressure chamber PC of the combustor. The gallium hydroxide and hot gas mixture flow into the gallium oxide conversion chamber GOC shown as an annular chamber below the gallium hydroxide chamber. Contained in the gallium oxide chamber GOC is a packed dehydrating bed of packing material suitably positioned at zone 20 inside the generator GEN. The packed bed works with application of heat from the hot gas mixture to convert the gallium hydroxide 16 to the gallium sesquioxide 19.

In other embodiments, it is not necessary for the hot gas mixture to travel through the dehydrator DE to obtain the heat required to dehydrate the gallium hydroxide to form the gallium sesquioxide. The hot gas mixture may, instead, flow in heat exchange relationship with the dehydrator. By way of example, the dehydrator may be disposed within the combustor, the hot gas mixture providing adequate heat to the dehydrator by flowing past the exterior of and in heat exchange relationship with the dehydrator and directly into the reducer. The dehydrator may also be constructed separate from the combustor and may utilize a different heat source for the required heat for dehydration of the gallium hydroxide.

The gallium sesquioxide 19 generated in the gallium oxide conversion chamber GOC and the hot gas mixture are expelled downstream into the reducer RC, the reducer including a packed reducing bed 21 supported on a perforated bottom plate BP.

In the operational mode, the hot gas mixture provides hydrogen gas, carbon monoxide, and heat to reduce the gallium sesquioxide 19 to gallium fuel Ga. Through the reducing bed, the gallium sesquioxide is reduced in the presence of reducing heat, hydrogen gas, and carbon monoxide provided by the hot gas mixture and forms a pressurized intermixture of liquid gallium fuel Ga and spent gases including carbon dioxide CO₂ and steam H₂O and may also include nitrogen N₂ and sometimes sulfur. The packed dehydrating and reducing beds may not be necessary to convert gallium hydroxide to gallium fuel. The beds, however, are believed to provide a greater degree of conversion of the gallium hydroxide and the gallium sesquioxide respectively.

The intermixture of liquid gallium fuel Ga and spent gases is expelled into the fuel separator GFS positioned immediately downstream of the reducer RC. The fuel separator includes a spent gas chamber SGC followed by a liquid gallium chamber GC. The liquid gallium Ga fuel flows under pressure to the downstream end of the generator GEN for collection as desired through a solenoid-actuated gallium fuel valve S2. The comparatively lighter pressurized spent gases may be expelled out of the fuel separator as desired by line 24 through a solenoid actuated three-way spent gas valve S1. In the present embodiment, the fuel separator separates the gallium fuel from the spent gases by gravitational force of the heavier gallium fuel. It is not intended, however, that the fuel separator be limited to separation by gravitational force, but also may include separation by centrifugal force and other means known to those skilled in the art.

Spent gases exit the generator via line 24 through spent gas valve S1. The temperature of the spent gases determines whether the spent gases will travel through the heat exchanger boiler via line 25 to the atmosphere or to be further processed via line 26 and provide a heating means 26A for transfer of the regenerated gallium fuel to the fuel tank.

In the startup mode, the temperature of the spent gas chamber SGC is less than 1100° F. In this mode, the spent gas flows through the spent gas valve S1 from zone 22 to line 24 through a heat exchanger boiler means HEB and through line 25 to the atmosphere. A processor (not shown) senses the spent gas temperature through a thermocouple T1 effects opening of the three way spent gas valve to line 25 to forward the spent gases from line 24 to the heat exchanger boiler HEB.

In the operational mode, the spent gas temperature is at least 1100° F. and the thermocouple T1 provides a signal to the processor to effect opening of the spent gas valve to line 26. When air is employed as the oxidizer 13 in the operational mode, the pressurized hot gas mixture from the oxidizing chamber OC flows into the pressure chamber PC and will contain hydrogen, carbon monoxide, nitrogen, and steam (it might also contain sulfur if that gas is present), at a pressure between about 20 psi to about 100 psi, and at a temperature more than 1100° F. to a preferred reaction temperature as required for recovering a liquid gallium Ga by conversion of gallium hydroxide 16 to gallium sesquioxide 19. The reduction of gallium sesquioxide 19 with reducing gases of hydrogen and carbon monoxide in the packed reducing bed produces pressurized spent gases in zone 22 of carbon dioxide, nitrogen, and steam and flows through the spent gas valve S1 from zone 22 to lines 24 and 26 through the heat exchanger boiler HEB to form a liquid gallium heater 26A. Meanwhile, the regenerated liquid gallium fuel Ga flows into zone 23 and the gallium chamber GC for collection and reuse by the liquid gallium fuel cell.

The pressurized liquid gallium Ga flows from zone 23 through the gallium fuel valve S2 and into line 27 to a liquid gallium tank LGT. The liquid gallium fuel in line 27 is maintained above 86° F. by heat exchange from the liquid gallium heater 26A which collects the relatively warmer spent gases. It is to be noted that pressures and temperatures referenced herein are measured with reference to sea level conditions.

In the operational mode, the temperature of the liquid gallium fuel Ga within the liquid gallium tank LGT is controlled at a temperature above 86° F. by a thermocouple T2 connected to the gallium tank, a tank heater 28 providing heat to the liquid gallium in the gallium tank, and a first heat exchanger HE1, the first heat exchanger connected via lines 39 and 40 to receive cooling water from a water pressure tank WPT for cooling the liquid gallium fuel as needed. The pressurized expelled spent gases from gas chamber SGC outflows through line 24, spent gas valve S1, line 26, gallium heater 26A, and line 29 to a water condenser WC. Spent gases of steam, carbon dioxide, and nitrogen are removed by way of line 30 to the atmosphere. Water usage and supply is controlled by an electronic processor (not shown). A propellant P powered coolant-metering pump CMP moves condensed water H₂O from the water condenser WC by way of lines 31, 32, and 34 and a check valve 33 to a water pressure tank WPT. A thermocouple T3 is connected with the water condenser, the processor, and the water pump CMP, to insure that water from the condenser is not pumped to the water pressure tank when the temperature of the water is at least 212° F. as measured at sea level. Air pressure 35 moves pressurized water H₂O from the water pressure tank to an electrolyte tank ET through line 36 to a fluid level valve 37 actuated by a float 38. Also, air pressure 35 moves pressurized water H₂O from the water pressure tank WPT to a first heat exchanger HE1 through lines 39 and 40 via a solenoid-actuated water valve S6 for cooling liquid gallium Ga contained by the liquid gallium tank LGT. Air pressure 35 in the water pressure tank WPT is monitored by a pressure sensor P4 mounted on the water pressure tank. The steam 41 generated from the first heat exchanger HE1 flows by way of line 42 back to the water condenser WC.

Air pressure 35 in water pressure tank WPT moves pressurized water H₂O to the heat exchanger boiler HEB through lines 63 and 64 through a solenoid-actuated boiler valve S7 for cooling the spent gases from the generator GEN in lines 25 and 26. Steam 65 from the heat exchanger boiler HEB flows through a high-pressure pump HPP1 by way of lines 66,67,26, gallium heater 26A, and line 29 to the water condenser WC. The propellant P powered high-pressure pump HPP1 moves air from the atmosphere by way of lines 68, 70 and a pressure check valve 69 to an air pressure tank APT. The air pressure tank includes a pressure sensor P2 for controlling the check valve 69. Contained air propellant P flows out of the air pressure tank to all the fluid-metering pumps MP as required.

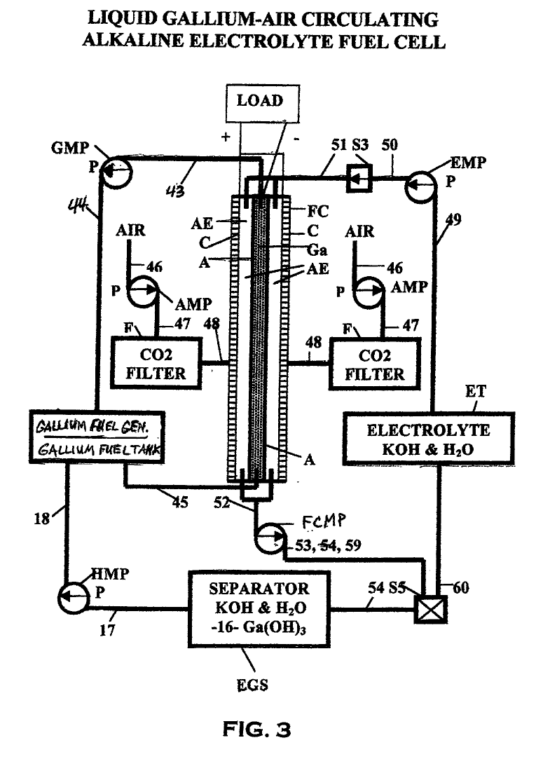

Referring to FIGS. 1-3, a propellant P powered gallium-metering pump GMP pumps the gallium fuel Ga from the liquid gallium tank LGT through lines 43 and 44 to and throughout a liquid gallium-air alkaline electrolyte fuel cell FC anode electrode A and returns unused liquid gallium fuel Ga back to tank LGT through line 45.

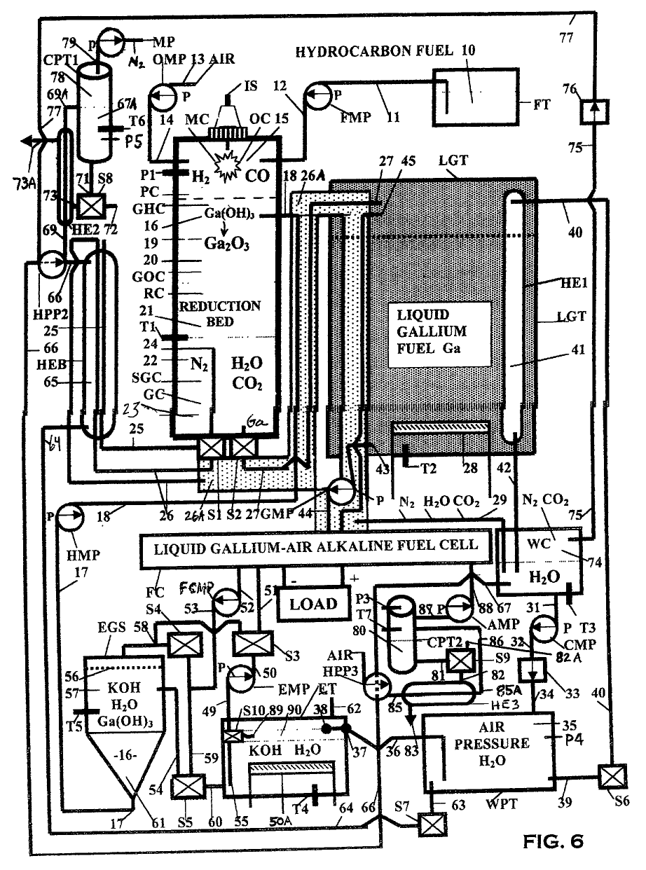

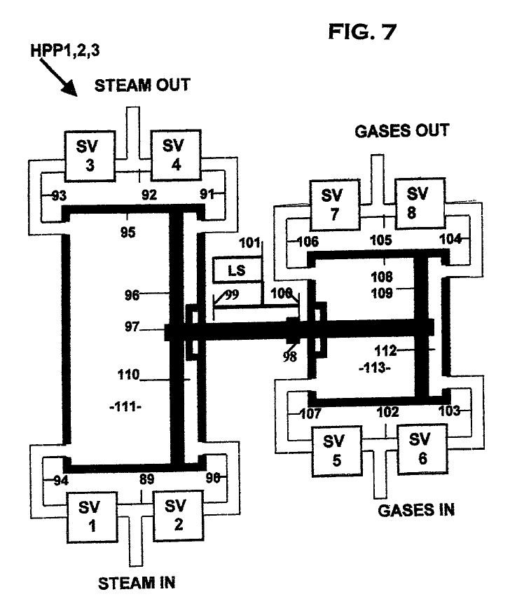

A propellant P powered air-metering pump AMP pumps air from the atmosphere by way of lines 46 and 47 throughout a carbon dioxide filter bed F for absorbing carbon dioxide and flows through line 48 as carbon dioxide-free air and throughout the cathode electrode C of the gallium-air alkaline electrolyte fuel cell FC. The carbon dioxide-free air provides oxygen gas for operation for the cathode electrode. Alternatively, carbon dioxide-free air is provided to the cathode via a carbon dioxide separator as shown in FIG. 6 and described below.

To replenish the aqueous electrolytic alkaline solution of the fuel cell, a propellant P powered electrolyte metering pump EMP pumps the solution containing potassium hydroxide (KOH) and water (H₂O) from the electrolyte tank ET by way of lines 49, 50 and 51 through a solenoid-actuated three-way electrolyte valve S3 to an electrolyte chamber AE of the fuel cell FC. The electrolyte tank also includes an electrolyte heater 50A activated by a signal from a thermocouple T4 mounted to the electrolyte tank. The heater is used to maintain adequate temperature of the electrolyte solution when moved to the fuel cell so as to maintain the at least 86° F. temperature required to keep, as desired, the gallium fuel in its liquid state at the gallium fuel and electrolyte solution interface in the fuel cell.

To replenish the gallium fuel spent in operation of the fuel cell, the spent gallium fuel in the form of gallium hydroxide is removed from the fuel cell and transferred to the gallium fuel generator via a pumping system coupled with an electrolyte gallium hydroxide separator EGS. A propellant P powered fuel cell metering pump FCMP moves an admixture 57 including the aqueous alkaline electrolyte solution in combination with dissolved gallium hydroxide by way of lines 52, 53, 54 and 59 through the solenoid-actuated three-way admixture valve S5 to the electrolyte gallium hydroxide separator EGS. The admixture is cooled by a heat exchanger (not shown) and thermocouple T5 together with the processor controls the temperature of the gallium hydroxide separation at about 70° F. The gallium hydroxide is pumped to the bottom side of a sintered stainless steel 1-4 micron filter 56. The electrolyte solution moves through said filter 56 by way of lines 58, 59 and 60 through a solenoid-actuated three-way solution valve S4 and admixture valve S5 returning to the electrolyte tank ET. The gallium hydroxide is collected by gravity to a settling hopper 61 of the gallium hydroxide separator EGS. Gallium hydroxide attached to the filter is removed by a backwash of electrolyte solution by the propellant P powered electrolyte metering pump EMP moving the electrolyte solution from the electrolyte tank ET by way of lines 49, 50 and 58 through electrolyte valve S3 to the electrolyte gallium hydroxide separator EGS. The gallium hydroxide 16 settles by gravitational force to a settling hopper 61 of the gallium hydroxide separator EGS and the electrolyte solution not needed as a carrier to transport gallium hydroxide to the generator moves by way of lines 54 and 60 through admixture valve S5 to the electrolyte tank ET. Spent hydrogen is vented from the electrolyte tank ET by way of line 62. It is to be noted that the term admixture as used herein is not to be limited to a meaning including only a homogeneous mixture, but may also include for example, a combination of unmixed heterogeneous components. It is also to be noted that the gallium hydroxide separator may be configured to separate gallium hydroxide from the admixture by other than filtration and gravitational forces such as, for example, by centrifugal force and other means as are known to those skilled in the art.

The packed bed materials in the dehydrator DE and the reducer RC are made from a variety of materials formed into balls or mesh structures including ceramic materials such as porcelain, mullite, alumina, zirconia, zircon, cordierite, fosterite, spodumene, perovskite, steatite, magnesia, silicon carbide, silicon nitride, beryllia and the like; glassy materials such as borosilicate, soda lime, flint, plate, alumina silicate, silica, quartz; and refractory metallic materials such as titanium, zirconium, hafnium, chromium, vanadium, niobium, tantalum, molybdenum and tungsten. It is important that the packed bed materials be inert toward gallium hydroxide, gallium sesquioxide, liquid gallium fuel and their container materials at temperatures in excess 2000° F. Catalysts may be useful to increase the speed of the dehydration and reduction reactions.

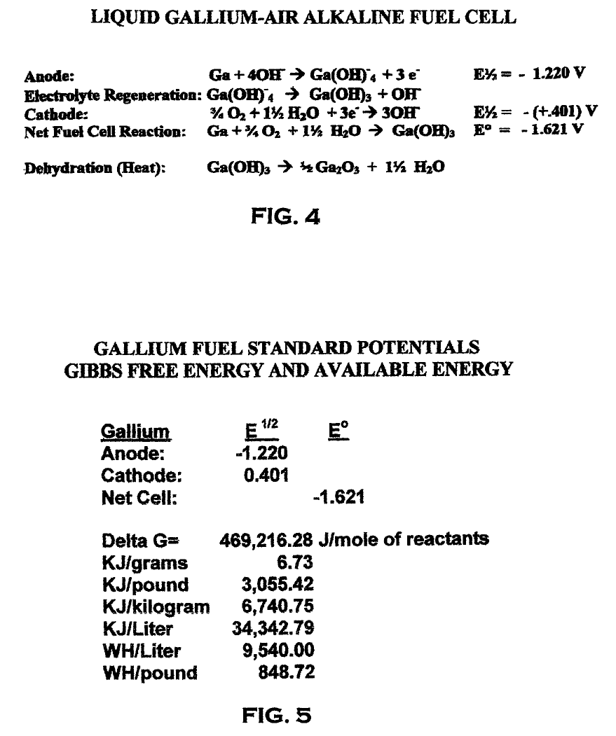

Referring to FIG. 4, in one embodiment a liquid gallium half reaction defines the fuel side (anode or negative electrode), an air breathing electrode half reaction defines the oxygen side (cathode or positive electrode) and the net reaction for anode and cathode is found by adding the two reactions of the liquid gallium-air fuel cell.

Referring to FIG. 5, the Gibbs Free Energy referred to as “delta G” for the net reaction of the liquid gallium-air fuel cell 469,216.28 J/mole of reactants. The energy available from one pound of liquid gallium fuel is 3055.42 kJ/pound or 6740.75 kJ/kilogram or 34,342.79 kJ/liter. In electrical terms 9,540-watt hours/liter or 848.72 watt hours/pound. As an energy comparison, the theoretical energy available in a liter of gasoline is about 33,000 kJ. So a liter of liquid gallium has about 104% of the theoretical energy available in a liter of gasoline.

Referring to FIG. 6, the air pressure 35 in the water pressure tank WPT moves pressurized water H₂O to the heat exchanger boiler HEB through lines 63 and 64 through the boiler valve S7 for cooling spent gases from spent gas chamber SGC in lines 25 and 26. Also a steam 65 outflow from heat exchanger boiler HEB is used as a pump propellant. The steam pump propellant flows by way of line 66 to two high-pressure pumps HPP2 and HPP3 and returns the used steam propellant through line 67 to the water condenser WC.

Utilizing a carbon dioxide separator, nitrogen gas N₂ may be separated from a spent nitrogen gas mixture 74 including spent nitrogen gas N₂ and spent carbon dioxide gas CO₂ by liquifying the spent carbon dioxide. The spent gas mixture 74 flows from the water condenser WC by way of line 75, check valve 76, line 77 and a high-pressure pump HPP2 pressurizing and forwarding the gas mixture 74 through a second heat exchanger HE2 by way of line 69. The second heat exchanger HE2 utilizes liquid carbon dioxide as a refrigerant received from a first carbon dioxide pressure tank CPT1 via line 71, a solenoid-actuated three-way carbon dioxide valve S8, and a refrigerant line 73, the refrigerant running through the second heat exchanger to liquify the carbon dioxide gas moving through line 69. The second heat exchanger cools the pressurized passing nitrogen gas mixture and liquifies the spent carbon dioxide gas forming an intermixture 69A of a nitrogen gas composition 78 and liquid carbon dioxide 67A. The liquid-phase range limits of temperature and pressure for carbon dioxide are about 59° F. to about 87° F. and about 734 psi to about 1052 psi. Pressure and temperature are monitored by a thermocouple T6 and a pressure sensor P5 mounted to the carbon dioxide pressure tank CPT1. The liquid carbon dioxide refrigerant in the heat exchanger absorbs heat from the relatively warmer surface of line 69 and is partially vaporized by sublimation through the second heat exchanger HE2, and exits the system through line 73A to the atmosphere. The intermixture flows into the first carbon dioxide pressure tank CPT1 where the denser liquid carbon dioxide 67A settles beneath the lighter nitrogen gas composition 78. The nitrogen gas composition 78 may then be expelled out of the carbon dioxide pressure tank via line 79 to conduct useful work, for example, as a propellant P for metering pumps MP. The liquid carbon dioxide 67A may be transferred via line 71 through the carbon dioxide valve S8 via line 72 to either a carbon dioxide storage tank (not shown) or via line 73 to the second heat exchanger HE2. The liquid carbon dioxide may also be routed to other applications such as another heat exchanger (not shown) to control the temperature, for example, of the separation of the gallium hydroxide from the electrolyte solution.

A second carbon dioxide separator may also be utilized to remove carbon dioxide from a gas mixture including an oxygen gas, such as air, by liquifying and separating the carbon dioxide from the gas mixture forming a carbon-dioxide-free oxygen gas composition which may then be fed to the cathode electrode C of the gallium fuel cell FC to produce hydroxyl ions for reaction with gallium fuel. For example, a high-pressure pump HPP3 draws in and pressurizes air gases from the atmosphere and forwards the pressurized air via line 85 through a third heat exchanger HE3 utilizing liquid carbon dioxide as a refrigerant. The third heat exchanger HE3 cools the air and liquifies the carbon dioxide gas component of the air in line 85 and yields a second intermixture 85A of carbon dioxide liquid 80 and carbon dioxide-free air in line 86 at the downstream end of the third heat exchanger HE3. The liquid-phase range limits of temperature and pressure for carbon dioxide are about 59° F. to about 87° F. and about 734 psi to about 1052 psi. When the relatively warmer pressurized air moves through the third heat exchanger, the liquid carbon dioxide refrigerant in the third heat exchanger absorbs heat from the surface of line 85 and is at least partially vaporized by sublimation and exits the system through vent line 83 to the atmosphere. The second intermixture flows by way of line 86 into a second carbon dioxide pressure tank CPT2 and the liquid carbon dioxide 80 settles in the second pressure tank beneath the carbon dioxide-free air. A propellant P powered air-metering pump device AMP moves the carbon dioxide-free air by way of lines 87 and 88 to the cathode electrode C of the gallium-air alkaline electrolyte fuel cell FC. A bleed valve (not shown) may also be used as the pump device to reduce the feed pressure of the carbon dioxide-free air to the cathode electrode. The pressurized carbon dioxide 80 is stored in a liquid state in the second pressure tank CPT2 and may be transferred via line 81 and a second solenoid-actuated three-way carbon dioxide valve S9 to a second carbon dioxide storage means 82A, such as a storage tank, or to the third heat exchanger HE3 via conduit line 82. A pressure sensor P3 connected to the second pressure tank monitors tank pressure to control a pressure check valve (not shown) in line 87 and to maintain liquid carbon dioxide 80 therein in its liquid state. A thermocouple T7 is also provided on the second pressure tank to sense temperature of the carbon dioxide 80 and provide a signal to the processor to maintain the carbon dioxide in its liquid state. The liquid carbon dioxide may also be routed to other applications such as an additional heat exchanger (not shown) to control the temperature, for example, of the separation of the gallium hydroxide from the electrolyte solution in the electrolyte gallium hydroxide separator EGS.

Referring to FIGS. 1, 3 and 6, a controller controls operation of the liquid gallium-air alkaline electrolyte fuel cell FC. Operation of the fuel cell can be controlled by replacement of the aqueous electrolytic alkaline solution, for example water (H₂O) and potassium hydroxide (KOH) solution, with a dielectric liquid 90. The controller includes an electrolyte tank ET containing an abundant supply of electrolyte solution and a supply of a suitable lightweight non-conductive or dielectric liquid, such as kerosene. The dielectric liquid 90 is lighter than the electrolyte solution and is such that it will not mix with the electrolyte solution. Accordingly, the dielectric liquid 90 normally remains in the tank ET atop and separate from the supply of electrolyte solution therein. (In practice, other dielectric liquids, such as mineral oil, might be used instead of kerosene).

When it is desired to put the fuel cell FC out of operation, a propellant P powered electrolyte metering pump EMP pumps the flow of dielectric liquid 90 through a solenoid-actuated three-way dielectric valve S10 from the tank ET by way of lines 89, 49, 50 and 51 through the electrolyte valve S3 to the electrolyte chamber AE of the gallium-air alkaline electrolyte fuel cell FC. A propellant P powered fuel cell metering pump FCMP pumps the electrolyte solution contained in the electrolyte chamber AE by way of lines 52, 53, 59 and 60 through the solenoid-actuated three-way admixture valve S5 back to the electrolyte tank ET. The continuing flow of dielectric liquid 90 from the electrolyte tank ET displaces the electrolyte solution therein and causes it to flow into and fill the fuel cell FC electrolyte chamber AE, thus stopping fuel cell operation. When the fuel cell FC electrolyte chamber AE is filled with the dielectric liquid, a valve (not shown) is operated to its closed position to stop further movement of dielectric liquid.

When it is desired to put the fuel cell FC back in operation, a propellant P powered electrolyte metering pump EMP moves the flow of electrolyte solution through the dielectric valve S10 from the electrolyte tank ET by way of lines 55, 49, 50 and 51 through the electrolyte valve S3 to the electrolyte chamber AE of the gallium-air alkaline electrolyte fuel cell FC. A propellant P powered fuel cell metering pump FCMP moves the dielectric liquid 90 by way of lines 52, 53, 59 and 60 through admixture valve S5 back to the electrolyte tank ET. The continuing flow of the electrolyte solution from the electrolyte tank ET displaces the dielectric liquid 90 therein and causes electrolyte to flow to and fill the fuel cell FC electrolyte chamber AE, thus starting fuel cell operation. Operation of the fuel cell may be increased or decreased by adjusting the electrolyte level in the fuel cell via the controller.

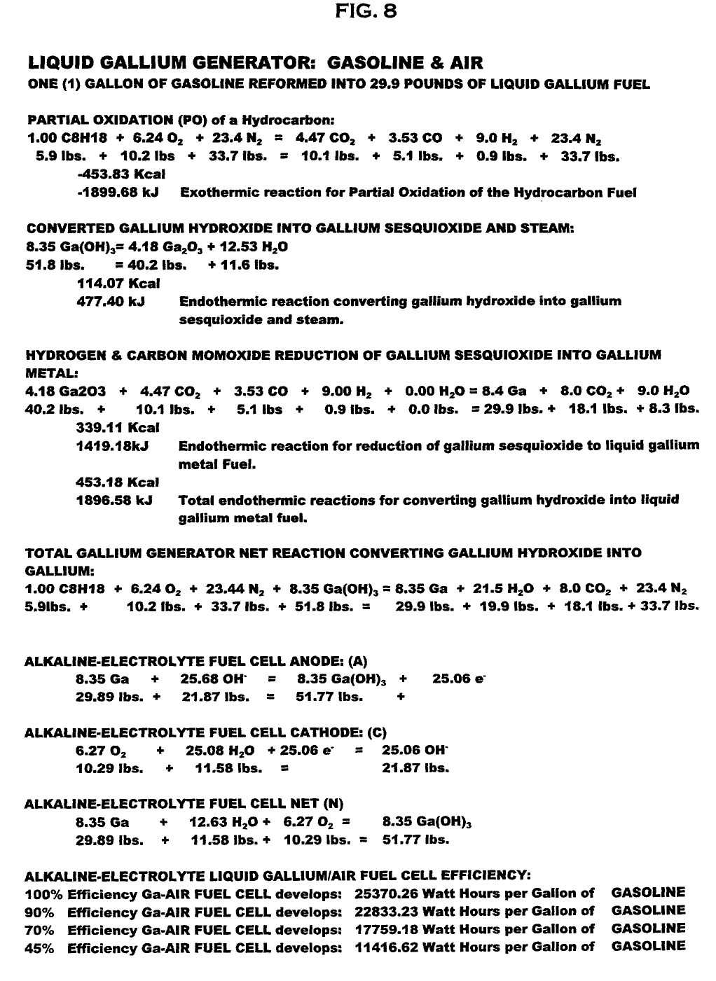

Referring to FIG. 7, I have set forth a direct acting reciprocating steam-fed high-pressure gas pumps HPP1, HPP2, and HPP3, each of which includes a rod 97, connecting pistons 96 and 109, rod chambers 110, 111, 112, and 113, cylinders 95 and 108, a rod collar 98, steam valves SV1, SV2, SV3, and SV4, gas valves SV5, SV6, SV7, and SV8, and a limit switch LS. The rod 97 is connected to pistons 96 and 109 that fill or empty chambers 110 and 112 and empty or fill chambers 111 and 113. Nearly double the flow rate (less the volume of the piston rod 97) over a single-acting force pump, such high-pressure gas pumps also smooth the flow. The pressurized steam propellant enters the high-pressure pump through line 89 where the steam valves SV1 and SV2, switch back and forth between lines 90 or 94 for intake and exhaust strokes. In gases enter the system through line 102 where the gas valves SV5 and SV6, switch back and forth between lines 103 or 107 for intake and exhaust strokes. Compressed out gases exit the system through lines 104 or 106 where the gas valves SV7 and SV8 switch back and forth between lines 104 and 106.

When the piston rod 97 of pistons 96 and 109 in cylinders 95 and 108 reaches the extreme right limit of its stroke, and rod collar 98 contacts limit 100 of limit switch LS and the following events occur in the following sequence:

The pressurized steam propellant from the heat exchanger HEB in line 66 for power the direct acting reciprocating steam high-pressure gas pumps HPP1, HPP2, and HPP3 and

(a) Steam valves SV2 and SV3 open, SV1 and SV4 close

(b) Gas valves SV6 and SV7 open, SV5 and SV8 close

(c) Pistons 96 and 109 starts to extend left

(d) Gases are compressed in lines 105 and 106.

When the piston rod 97 of pistons 96 and 109 in cylinders 95 and 108 reaches the extreme left limit of its stroke, and rod collar 98 contacts limit 99 of limit switch LS and the following events occur in the following sequence:

(e) Steam valves SV1 and SV4 open, SV2 and SV3 close

(f) Gas valves SV5 and SV8 open, SV6 and SV7 close

(g) Pistons 96 and 109 starts to extend right

(h) Gases are compressed in lines 104 and 105.

Referring to FIGS. 8-13 of the drawings I have set forth-theoretical weights or amounts of products, and reactants used in carrying out the invention from one gallon of a variety of hydrocarbon fuels as a base line such as gasoline, propane, methanol, ethanol, kerosene, and pentane fuels and air from the atmosphere are fed into the liquid gallium fuel generator system and apparatus in combination with liquid gallium-air alkaline electrolyte fuel cells.

Referring to FIG. 8, a theoretical computation of chemical formula of a gasoline fueled, liquid gallium fuel generator is shown. The theoretical weights or amounts of products and reactants used in carrying out this generator invention starts with one gallon of gasoline C₈H₁₈ as a base line and 43.95 pounds of air from the atmosphere. The hydrocarbon fuel and air are fed into combustor section of the generator and 51.8 pounds of gallium hydroxide Ga(OH)₃ is fed into dehydrator. The net generator products of reaction are 29.9 pounds of liquid gallium fuel and pressurized spent gases of 18.1 pounds of carbon dioxide (CO₂), 19.9 pounds of water H₂O, 33.7 pounds of nitrogen N₂. The liquid gallium-air alkaline electrolyte fuel cell at 100 percent efficiency generates 25,370-watt hours per one gallon of gasoline fuel theoretical power minus all the power inefficiencies.

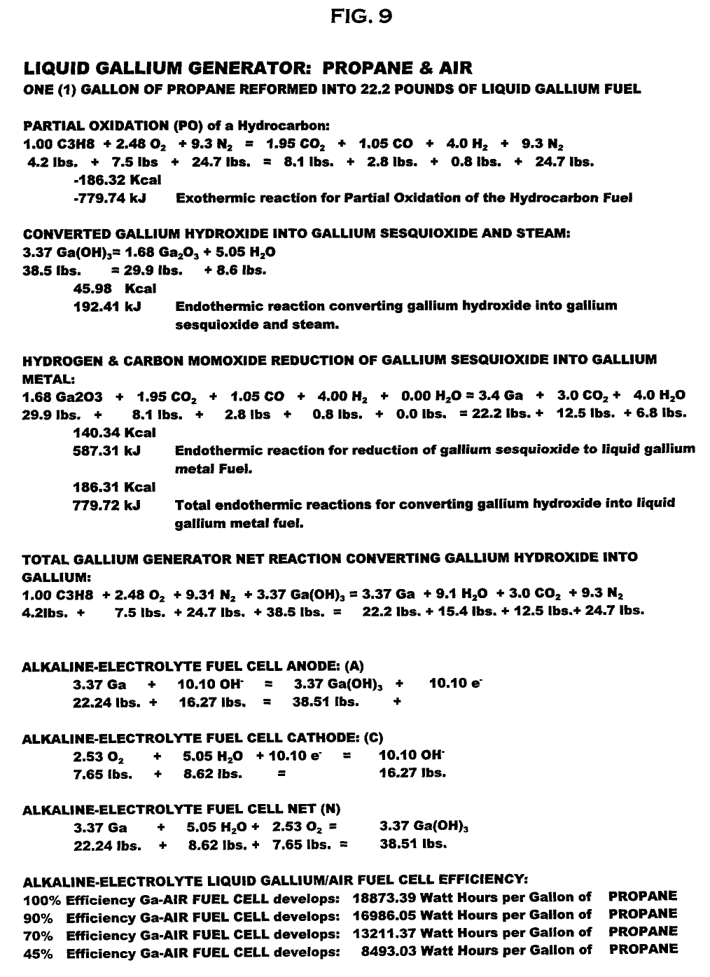

Referring to FIG. 9, a theoretical computation of chemical formula of a propane fueled, liquid gallium fuel generator is shown. The theoretical weights or amounts of products and reactants used in carrying out this generator invention starts with one gallon of propane C₃H₈ as a base line and 32.2 pounds of air from the atmosphere. The hydrocarbon fuel and air are fed into the combustor section of the generator and 38.5 pounds of gallium hydroxide Ga(OH)₃ is fed into dehydrator. The net generator products of reaction are 22.2 pounds of liquid gallium fuel and pressurized spent gases of 12.5 pounds of carbon dioxide (CO₂), 15.4 pounds of water H₂O, 24.7 pounds of nitrogen N₂. The liquid gallium-air alkaline electrolyte fuel cell at 100 percent efficiency generates 18,873-watt hours per one gallon of propane fuel theoretical power minus all the power inefficiencies.

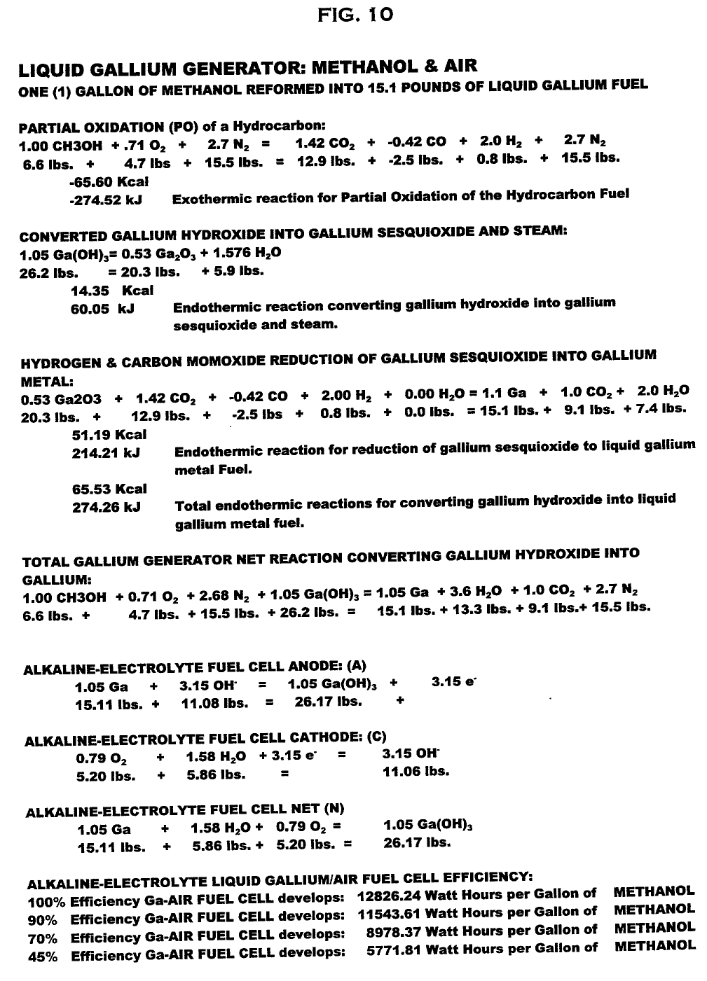

Referring to FIG. 10, a theoretical computation of chemical formula of a methanol fueled, liquid gallium fuel generator is shown. The theoretical weights or amounts of products and reactants used in carrying out this generator invention starts with one gallon of methanol CH₃OH as a base line and 20.2 pounds of air from the atmosphere. The hydrocarbon fuel and air are fed into combustor section of the generator and 26.2 pounds of gallium hydroxide Ga(OH)₃ is fed into the dehydrator. The net generator products of reaction are 15.1 pounds of liquid gallium fuel and pressurized spent gases of 9.1 pounds of carbon dioxide (CO₂), 13.3 pounds of water H₂0, 15.5 pounds of nitrogen N₂. The liquid gallium-air alkaline electrolyte fuel cell at 100 percent efficiency generates 12,826-watt hours per one gallon of methanol fuel theoretical power minus all the power inefficiencies.

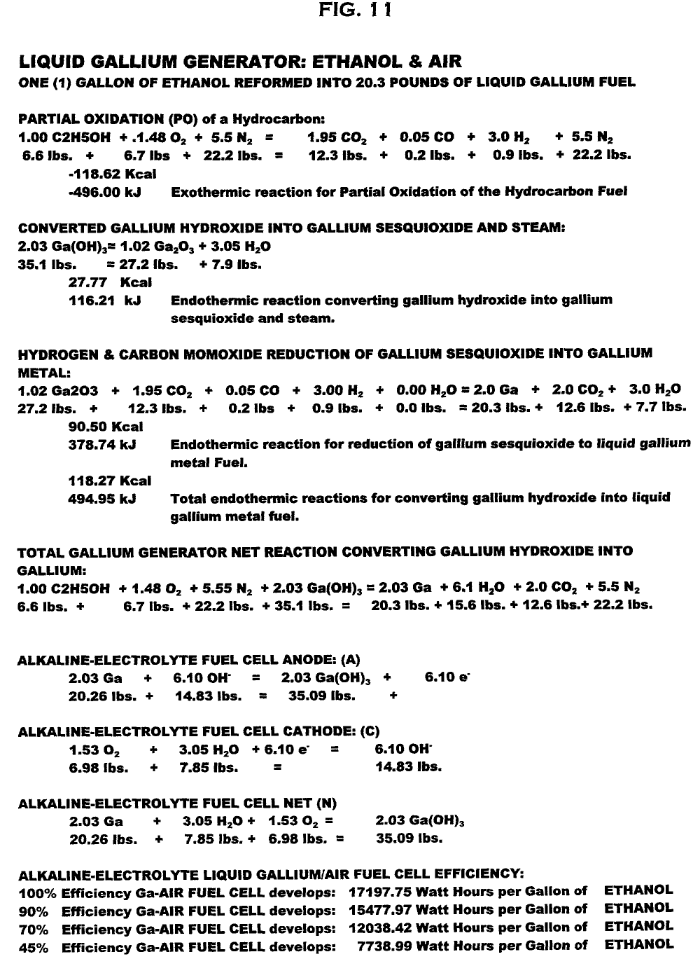

Referring to FIG. 11, a theoretical computation of chemical formula of an ethanol fueled, liquid gallium fuel generator is shown. The theoretical weights or amounts of products and reactants used in carrying out this generator invention starts with one gallon of ethanol C₂H₅OH as a base line and 28.9 pounds of air from the atmosphere. The hydrocarbon fuel and air are fed into the combustor section of the generator and 35.1 pounds of gallium hydroxide Ga(OH)₃ is fed into the dehydrator. The net generator products of reaction are 20.3 pounds of liquid gallium fuel and pressurized spent gases of 12.6 pounds of carbon dioxide (CO₂), 15.6 pounds of water H₂O, 22.2 pounds of nitrogen N₂. The liquid gallium-air alkaline electrolyte fuel cell at 100 percent efficiency generates 17,198-watt hours per one gallon of ethanol fuel theoretical power minus all the power inefficiencies.

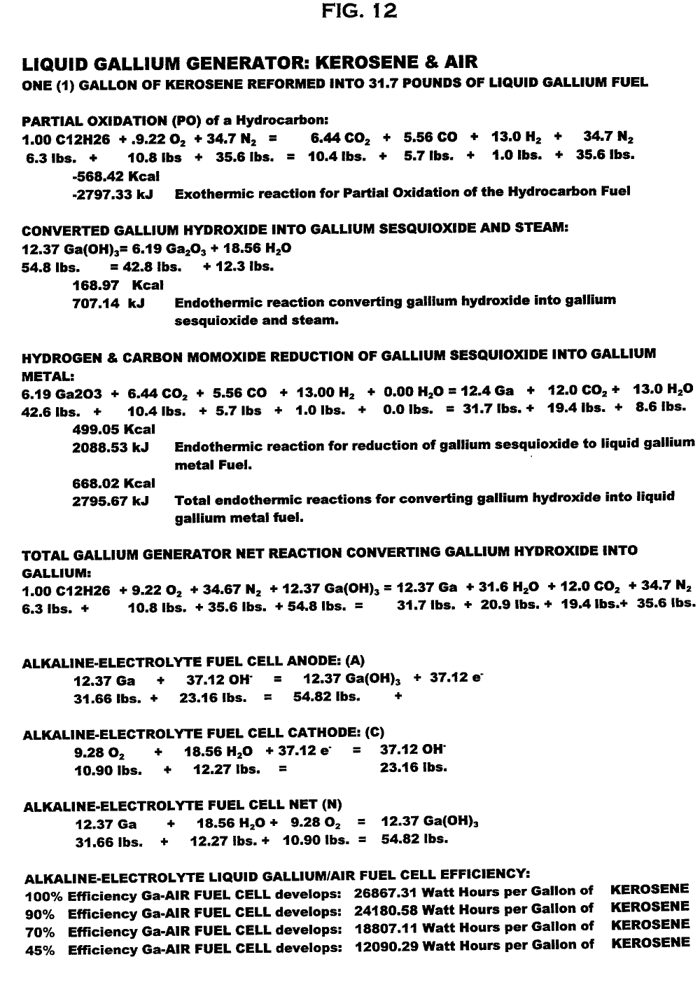

Referring to FIG. 12, a theoretical computation of chemical formula of a kerosene fueled, liquid gallium fuel generator is shown. The theoretical weights or amounts of products and reactants used in carrying out this generator invention starts with one gallon of kerosene C₁₂H₂₆ as a base line and 46.46 pounds of air from the atmosphere. The hydrocarbon fuel and air are fed into the combustor section of the generator and 54.8 pounds of gallium hydroxide Ga(OH)₃ is fed into the dehydrator. The net generator products of reaction are 31.7 pounds of liquid gallium fuel and pressurized spent gases of 19.4 pounds of carbon dioxide (CO₂), 20.9 pounds of water H₂O, 35.6 pounds of nitrogen N₂. The liquid gallium-air alkaline electrolyte fuel cell at 100 percent efficiency generates 26,867-watt hours per one gallon of kerosene fuel theoretical power minus all the power inefficiencies.

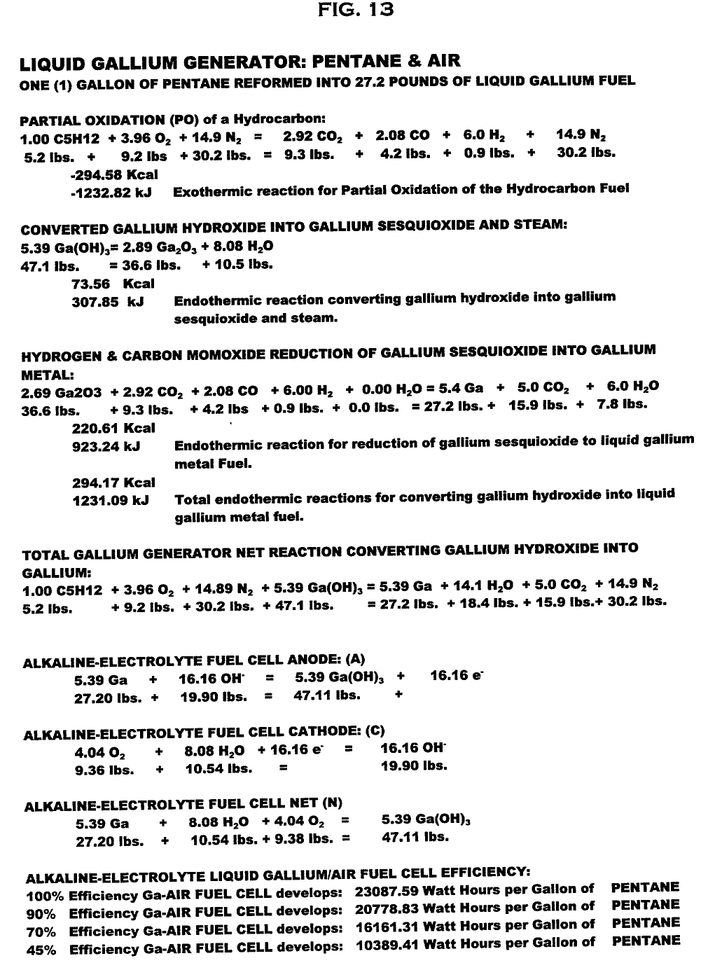

Referring to FIG. 13, a theoretical computation of chemical formula of a pentane fueled, liquid gallium fuel generator is shown. The theoretical weights or amounts of products and reactants used in carrying out this generator invention starts with one gallon of pentane C₅H₁₂ as a base line and 39.39 pounds of air from the atmosphere. The hydrocarbon fuel and air are fed into the combustor section of the generator and 47.1 pounds of gallium hydroxide Ga(OH)₃ is fed into the dehydrator. The net generator products of reaction are 27.2 pounds of liquid gallium fuel and pressurized fuel spent gases of 15.9 pounds of carbon dioxide (CO₂), 18.4 pounds of water H₂O, 30.2 pounds of nitrogen N₂. The liquid gallium-air alkaline electrolyte fuel cell at 100 percent efficiency generates 23,088-watt hours per one gallon of pentane fuel theoretical power minus all the power inefficiencies.

Not unlike other fuel cells, the liquid gallium fuel cell FC does not operate at 100 percent efficiency. Thermal and chemical reaction losses may be sustained in the fuel cell FC. Additionally, combustion and thermal inefficiencies and chemical reaction losses cause loss of energy in the liquid gallium fuel generator. Therefore, the power output of the hydrocarbon fueled, liquid gallium fuel generator in combination with the fuel cell FC is equal to the theoretical power minus all the power losses.

### Operation of the System With a Representative Fuel

An electronic processor (not shown) regulates fluid-metering pumps MP, power propellant P, ignition system IS, heat exchangers HE1-3, heat exchanger boiler HEB, fuel cell system FC, water condenser WC, solenoid actuated valves S1-S10, steam valves SV1-SV8, thermocouples T1-T7, and pressure sensors P1-P4.

Referring to FIG. 9, as shown in the theoretical computation of chemical formula using propane fuel in an operational startup mode, the propane fuel 10 and an air oxidizer 13, the system completely oxidizes the fuel in the oxidizing chamber OC. The exothermic chemical reaction of C₃H₈+4 H₂+7 O₂+11.28 N₂→3 CO₂+8 H₂O+11.28 N₂ ΔH₂₉₈=−2220 kJ heats the gallium fuel generator to an operational temperature of about 1100° F. in a few seconds. The thermocouple T1 controls the spent gas valve S1 and routes the spent gases from the spent gas chamber SGC prior to attaining an operational temperature from zone 22 to lines 24 and 25 and through the heat exchanger boiler HEB to the atmosphere.

In an operational mode, propane fuel 10 and air oxidizer 13 partially oxidizes the hydrocarbon fuel in the oxidizing chamber OC. The exothermic chemical reaction of C₃H₈+2.48 O₂+9.31 N₂→1.95 CO₂+1.05 CO+4.00 H₂+9.31 N₂ ΔH₂₉₈=−779.74 kJ heats the generator to sustain operational temperature. A temperature of about at least 1100° F. is required in zones 20 and 21 for the conversion of gallium hydroxide into gallium sesquioxide 19 and reduction with reducing hydrogen and carbon monoxide gases into liquid gallium fuel Ga in zone 23. The pressurized liquid gallium Ga flows from zone 23 through the gallium fuel valve S2 and line 27 to the liquid gallium tank LGT. The liquid gallium fuel Ga in line 27 is kept liquid at more than 86° F. by heat exchange with the liquid gallium heating means 26A including the expelled spent gases from the spent gas chamber. Regulating the ratio of oxidizer to hydrocarbon fuel controls the exothermic temperature of the oxidizer chamber.

In the operational mode, gallium hydroxide 16 is converted in the dehydrating bed in zone 20 by heat to gallium sesquioxide 19. The dehydrating heat is provided by the hot gas mixture expelled from the combustor into the dehydrator. The endothermic chemical reaction of 3.37 Ga(OH)₃→1.68 Ga₂O₃+5.05 H₂O ΔH₂₉₈=192.41 kJ controls the heat of the dehydrator to a sustained operational temperature and varies with water content of the gallium hydroxide 16.

In the operational mode, the gallium sesquioxide and the hot gas mixture including reducing gases of hydrogen and carbon monoxide next advance and flow downstream from the dehydrating bed in zone 20 into and throughout the reducing bed 21 of the reducer RC to form an intermixture of gallium fuel and spent gases including carbon dioxide, nitrogen, steam, and sometimes sulfur in zone 22. The endothermic chemical reaction of 1.68 Ga₂O₃+1.95 CO₂+1.05 CO+4 H₂→3.4 Ga+3 CO₂+4 H₂O ΔH₂₉₈=587.31 kJ controls the heat of the reducer RC to a sustained operational temperature by reduction of gallium sesquioxide 19 into liquid gallium fuel Ga. The total endothermic reactions converting gallium hydroxide into liquid gallium fuel Ga is ΔH₂₉₈=779.72 kJ.

A liquid gallium half reaction that defines the fuel side of a liquid gallium-air fuel cell (anode or negative) is 3.37 Ga+10.1 OH⁻→3.37 Ga(OH)₃+10.1 e⁻, the half reaction of an air breathing electrode defining the oxygen side of the cell (cathode or positive) is 2.53 O₂+5.05 H₂O+10.1 e⁻→10.1 OH⁻ and the net reaction by adding the anode and the cathode reactions of the liquid gallium-air fuel cell is 3.37 Ga+5.05 H₂O+2.53 O₂→3.37 Ga(OH)₃. The total net chemical reaction of converting gallium hydroxide to liquid gallium fuel is C₃H₈+3.37 Ga(OH)₃+2.48 O₂+9.31 N₂→3.4 Ga+3 CO₂+9.1 H₂O+9.31 N₂.

Having described only typical preferred forms and applications of my invention, I do not wish to be limited to the specific details here in set forth but wish to reserve to myself any modifications and/or variations that might appears to those skilled in the art and that fall within the scope of the following claims.

While a particular form of the invention has been illustrated and described, it will also be apparent to those skilled in the art that various modifications can be made without departing from the spirit and scope of the invention. Accordingly, it is not intended that the invention be limited except by the appended claims.

What is claimed is:

1. A liquid gallium fuel cell system including a gallium fuel generator configured to generate liquid gallium fuel from spent gallium fuel, comprising:
a fuel cell utilizing liquid gallium fuel and an aqueous electrolytic alkaline solution to produce electricity and form an admixture including the solution and spent gallium fuel in the form of gallium hydroxide;
a gallium hydroxide separator configured to receive the admixture and recover the gallium hydroxide from the admixture; and
a gallium fuel generator configured to receive and convert the gallium hydroxide to gallium fuel, comprising a combustor configured to receive a hydrocarbon fuel and oxygen gas and to mix them together to form a combustible gas mixture to generate, upon being ignited, a pressurized hot gas mixture including hydrogen gas and carbon monoxide; an ignitor disposed in the combustor to ignite the combustible mixture; a dehydrator connected to the combustor for receipt of the hot gas mixture therefrom and configured to receive the gallium hydroxide to dehydrate the gallium hydroxide and form gallium sesquioxide; a reducer connected to the dehydrator for receipt of the hot gas mixture and the gallium sesquioxide therefrom to reduce the gallium sesquioxide and form a gallium fuel intermixture of the gallium fuel and spent gases; and a fuel separator connected to the reducer for receipt of the fuel intermixture to separate the gallium fuel from the spent gases and recover the gallium fuel.

2. The system of claim 1, further comprising a means to transport the recovered gallium fuel to a gallium fuel tank for use in replenishment of the gallium fuel in the fuel cell.

3. The system of claim 1, wherein the spent gases include carbon dioxide and nitrogen gas and wherein a carbon dioxide separator is connected with the fuel separator for separating carbon dioxide from the spent gases to provide nitrogen gas as a pump propellant.

4. The system of claim 1, wherein the fuel cell includes an air breathing cathode electrode that requires carbon dioxide-free air to form hydroxyl ions and wherein a carbon dioxide separator means is configured to supply the carbon dioxide-free air to the cathode.

5. A liquid gallium fuel cell system including a gallium fuel generator to generate liquid gallium fuel from spent gallium fuel, comprising:
a fuel cell utilizing liquid gallium fuel and an aqueous electrolytic alkaline solution to produce electricity and spent gallium fuel in the form gallium hydroxide;
a generator means to generate liquid gallium fuel from spent gallium fuel;
a first conduit means including a first pump device connecting the fuel cell with the generator means to transfer the spent fuel to the generator; and
a second conduit means including a second pump device connecting the generator to the fuel cell to transfer the gallium fuel to the fuel cell.

6. A method for removing and converting spent gallium fuel, in the form of gallium hydroxide, from a liquid gallium fuel cell to gallium fuel for reuse in the fuel cell, the gallium hydroxide being included in an admixture including an aqueous electrolytic alkaline solution contained in an ion exchange chamber of the fuel cell, including:
removing at least a portion of the admixture from the fuel cell;
forcing the removed admixture through a filter media to separate the gallium hydroxide from the solution;
removing the gallium hydroxide from the filter media;
collecting the gallium hydroxide into a container;
injecting a hydrocarbon fuel and oxygen gas into a combustor
mixing together in the combustor the hydrocarbon fuel and oxygen gas to form a combustible gas mixture to generate, upon being ignited, a pressurized hot gas mixture including hydrogen gas and carbon monoxide;
igniting the combustible mixture;
expelling the hot gas mixture into a dehydrator to provide heat for the dehydration of the gallium hydroxide to form gallium sesquioxide;
introducing the gallium hydroxide from the container into the dehydrator;
dehydrating the gallium hydroxide to form gallium sesquioxide;
expelling the gallium sesquioxide and the hot gas mixture into a reducer to reduce the gallium sesquioxide to the gallium fuel and form and form an intermixture of the gallium fuel and spent gases; and
expelling the intermixture into a fuel separator to separate the gallium fuel from the spent gases; and
collecting the gallium fuel from the fuel separator.

7. A gallium fuel generator for generating gallium fuel from gallium hydroxide, comprising:
a combustor configured to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator connected to the combustor for receipt of the hot gas mixture therefrom and configured to receive the gallium hydroxide to dehydrate the gallium hydroxide and form gallium sesquioxide;
a reducer connected to the dehydrator for receipt of the hot gas mixture and the gallium sesquioxide therefrom to reduce the gallium sesquioxide and form a gallium fuel intermixture of the gallium fuel and spent gases; and
a fuel separator connected to the reducer for receipt of the fuel intermixture to separate the gallium fuel from the spent gases and recover the gallium fuel.

8. The generator of claim 7, wherein the dehydrator is further configured to include a dehydrating bed.

9. The generator of claim 8, wherein the reducer is further configured to include a reducing bed.

10. The generator of claim 9, wherein the reducer is further configured to include a perforated bottom plate supporting the reducing bed.

11. A gallium fuel generator for generating gallium fuel from gallium hydroxide, comprising:
a combustor to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator connected to the combustor for receipt of the hot gas mixture therefrom and configured to receive the gallium hydroxide to dehydrate the gallium hydroxide and form gallium sesquioxide;
a reducer connected to the dehydrator for receipt of the hot gas mixture and the gallium sesquioxide therefrom to reduce the gallium sesquioxide and form a gallium fuel intermixture of the gallium fuel and spent gases; and
a separator means connected to the reducer for receipt of the fuel intermixture to separate the gallium fuel from the spent gases and recover the gallium fuel.

12. A gallium fuel generator for generating gallium fuel from gallium hydroxide, comprising:
a combustor including means to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator connected to the combustor for receipt of the hot gas mixture therefrom and configured to receive the gallium hydroxide to dehydrate the gallium hydroxide and form gallium sesquioxide;
a reducer connected to the dehydrator for receipt of the hot gas mixture and the gallium sesquioxide therefrom to reduce the gallium sesquioxide and form a gallium fuel intermixture of the gallium fuel and spent gases; and
a fuel separator connected to the reducer for receipt of the fuel intermixture to separate the gallium fuel from the spent gases and recover the gallium fuel.

13. A gallium fuel generator for generating gallium fuel from gallium hydroxide, comprising:
a combustor configured to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator connected to the combustor for receipt of the hot gas mixture therefrom and configured to receive the gallium hydroxide to dehydrate the gallium hydroxide and form gallium sesquioxide;
a reducer means connected to the dehydrator for receipt of the hot gas mixture and the gallium sesquioxide therefrom to reduce the gallium sesquioxide and form a gallium fuel intermixture of the gallium fuel and spent gases; and
a fuel separator connected to the reducer means for receipt of the fuel intermixture to separate the gallium fuel from the spent gases and recover the gallium fuel.

14. A gallium fuel generator for generating gallium fuel from gallium hydroxide, comprising:
a combustor configured to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator disposed in heat exchange relationship with the combustor and configured to receive the gallium hydroxide to dehydrate the gallium hydroxide and form gallium sesquioxide;
a reducer connected to the combustor for receipt of the hot gas mixture therefrom and connected to the dehydrator for receipt of the gallium sesquioxide therefrom to reduce the gallium sesquioxide and form a gallium fuel intermixture of the gallium fuel and spent gases; and
a fuel separator connected to the reducer for receipt of the fuel intermixture to separate the gallium fuel from the spent gases and recover the gallium fuel.

15. A gallium fuel generator for generating gallium fuel from gallium hydroxide, comprising:
a combustor configured to receive a hydrocarbon fuel and oxygen gas and to mix them together to form a combustible gas mixture to generate, upon being ignited, a pressurized hot gas mixture including hydrogen gas and carbon monoxide;
an ignitor disposed in the combustor to ignite the combustible mixture;
a dehydrator configured to receive and dehydrate the gallium hydroxide and form gallium sesquioxide;
a reducer connected to the combustor for receipt of the hot gas mixture therefrom and connected to the dehydrator for receipt of the gallium sesquioxide therefrom to reduce the gallium sesquioxide and form a gallium fuel intermixture of the gallium fuel and spent gases; and
a fuel separator connected to the reducer for receipt of the fuel intermixture to separate the gallium fuel from the spent gases and recover the gallium fuel.

16. A method for recovering gallium fuel from an admixture including an aqueous electrolytic alkaline solution and gallium hydroxide, including:
forcing the admixture through a filter media to separate the gallium hydroxide from the solution;
collecting the gallium hydroxide from the filter media;
injecting a hydrocarbon fuel and oxygen gas into a combustor;
mixing together in the combustor the hydrocarbon fuel and oxygen gas to form a combustible gas mixture to generate, upon being ignited, a pressurized hot gas mixture including hydrogen gas and carbon monoxide;
igniting the combustible mixture to form the pressurized hot gas mixture;
expelling the hot gas mixture into a dehydrator to provide heat for the dehydration of the gallium hydroxide to form gallium sesquioxide; introducing the gallium hydroxide into the dehydrator;
dehydrating the gallium hydroxide to form gallium sesquioxide;
expelling the gallium sesquioxide and the hot gas mixture into a reducer to reduce the gallium sesquioxide to the gallium fuel and form and form an intermixture of the gallium fuel and spent gases; and
expelling the intermixture into a fuel separator to separate the gallium fuel from the spent gases; and
collecting the gallium fuel from the fuel separator.

17. A gallium hydroxide separator for recovering gallium hydroxide from an admixture of aqueous alkaline electrolyte and gallium hydroxide, comprising:
a filter being disposed to receive the admixture to separate the gallium hydroxide from the admixture;
a pump device connected with the admixture providing the admixture to the filter; and
a gallium hydroxide collector configured to collect the gallium hydroxide from the filter.

18. The gallium hydroxide separator of claim 17, wherein the collector is further configured to provide a wash of liquid to remove the gallium hydroxide attached to the filter.

19. The gallium hydroxide separator of claim 18, wherein the collector is further configured to provide a liquid carrier to transfer the collected gallium hydroxide to a gallium fuel generator for converting gallium hydroxide to gallium fuel.

20. A method for recovering gallium hydroxide from an admixture of aqueous alkaline electrolyte solution and gallium hydroxide, including:
forcing the admixture through a filter disposed to separate the gallium hydroxide from the admixture;
removing the filtered gallium hydroxide from the filter with a wash of liquid; and
collecting the gallium hydroxide and liquid in a container.

21. A carbon dioxide separator for removing carbon dioxide from a gas mixture that includes oxygen gas, comprising:
a heat exchanger utilizing liquid carbon dioxide as a refrigerant to liquify carbon dioxide gas moving through the heat exchanger, and including a vent for expulsion of carbon dioxide vapor;
a first pump device to pressurize and transport the gas mixture through the heat exchanger at a pressure and temperature to liquify the carbon dioxide of the mixture and form a resulting intermixture that includes oxygen gas and liquid carbon dioxide; and
a pressure tank connected with the first pump device to receive and separate the liquid carbon dioxide from the resulting intermixture forming a gas composition free of carbon dioxide.

22. The carbon dioxide separator of claim 21, further comprising a second pump device connected with the pressure tank for expelling the composition from the tank.

23. The carbon dioxide separator of claim 21, further comprising a second pump device connected with the pressure tank for expelling the composition from the tank and a means connected to the second pump device to provide the composition to an oxygen breathing cathode of a fuel cell.

24. The carbon dioxide separator of claim 22, further comprising a third pump device connected with the pressure tank and with the heat exchanger for providing the separated liquid carbon dioxide to the heat exchanger for use as the refrigerant.

25. A method for removing carbon dioxide from a gas mixture that also includes oxygen gas, including:
providing a heat exchanger utilizing liquid carbon dioxide as a refrigerant to liquify carbon dioxide gas moving through the heat exchanger, and including a vent for expulsion of carbon dioxide vapor;
providing a first pump device to pressurize and transport the gas mixture through the heat exchanger at a pressure and temperature to liquify the gaseous carbon dioxide and form a resulting intermixture that includes oxygen gas and liquid carbon dioxide;
providing a pressure tank connected with the first pump device to receive and separate the liquid carbon dioxide from the resulting intermixture forming a gas composition free of carbon dioxide; and
pumping the gas mixture through the heat exchanger forming the intermixture; and
separating in the pressure tank the liquid carbon dioxide from the intermixture forming the gas composition free of carbon dioxide.

26. A carbon dioxide separator for removing carbon dioxide from a gas mixture that also includes nitrogen gas, comprising:
a heat exchanger utilizing liquid carbon dioxide as a refrigerant to liquify carbon dioxide gas moving through the heat exchanger, and including a vent for expulsion of carbon dioxide vapor;
a first pump device connected to the gas mixture to pressurize and move the gas mixture through the heat exchanger at a pressure and temperature to liquify the gaseous carbon dioxide and form a resulting intermixture that includes nitrogen gas and liquid carbon dioxide; and
a pressure tank connected with the first pump device to receive and separate the liquid carbon dioxide from the resulting intermixture forming a gas composition free of carbon dioxide.

27. The carbon dioxide separator of claim 26, further comprising a second pump device connected with the pressure tank for expelling the gas composition from the tank.

28. The carbon dioxide separator of claim 27, further comprising a third pump device connected with the pressure tank and with the heat exchanger for providing the separated liquid carbon dioxide to the heat exchanger for use as the refrigerant.

29. A method for removing carbon dioxide from a gas mixture that also includes nitrogen gas, including:
providing a heat exchanger utilizing liquid carbon dioxide as a refrigerant to liquify carbon dioxide gas moving through the heat exchanger, and including a vent for expulsion of carbon dioxide vapor;
providing a first pump device to pressurize and transport the gas mixture through the heat exchanger at a pressure and temperature to liquify the gaseous carbon dioxide and form a resulting intermixture that includes nitrogen gas and liquid carbon dioxide;
providing a pressure tank connected with the first pump device to receive and separate the liquid carbon dioxide from the resulting intermixture forming a gas composition free of carbon dioxide; and
pumping the gas mixture through the heat exchanger forming the intermixture; and
separating in the pressure tank the liquid carbon dioxide from the intermixture forming the gas composition free of carbon dioxide.
